(19) United States
(12) Patent Application Publication
(10) Pub. No.: US 2017/0120157 A1
(43) Pub. Date: May 4, 2017

(54) ASSEMBLED BLOCK SET, ASSEMBLED BLOCK OPERATION DEVICE, AND WEB SYSTEM

(71) Applicant: BLD ORIENTAL CO., LTD., Izumisano-City (JP)

(72) Inventor: Yasushi Ochi, Osaka (JP)

(21) Appl. No.: 15/122,235

(22) PCT Filed: Mar. 5, 2015
(86) PCT No.: PCT/JP2015/001194

§ 371 Date: Aug. 29, 2016

(30) Foreign Application Priority Data
Apr. 1, 2014 (JP) 2014-075053

(51) Int. Cl. A63H 33/06; A63H 33/10; A23G 3/50; A47B 47/04; B43L 19/00; A63H 33/08; A63H 33/04

(52) U.S. Cl. CPC A63H 33/065; A63H 33/086; A63H 33/088; A63H 33/107; A63H 33/042; A47B 47/047; B43L 19/00; A23G 3/50; A23V 2002/00

(57) ABSTRACT

To provide a block that makes connection possible even using a flexible material.

The present invention relates to an assembled block set (500) that can be assembled from assembly blocks (100) formed from elastic materials, from rigid materials, or from an elastic material and a rigid material. Through-holes are formed in the assembly blocks (100), and assembly is possible using assembly stick blocks that pass through the through-holes in the blocks (100).

### TECHNICAL FIELD

The present invention relates to an assembled block set, operation device, and WEB system.

### BACKGROUND ART

The tool for ornament that can assemble like blocks is known. For example, a block amusement device is disclosed as an example of the tool for ornament in the following patent document 1.

### Related art Documents

Patent Document:

Patent Document 1: Japanese Unexamined Pat. App. Pub. No. 2012-228504

### SUMMARY OF THE INVENTION

### Problem Invention is to Solve

Present invention provides an assembled block that a main bodies of block connect to one another like above block toy. The block toy disclosed in the above patent document keeps keeps a side connection part of corresponding two blocks body by connecting on the same straight line by binding means. Therefore, an amusement device needs to be hard material formed of high polymer resin.

On the other hand, users may enjoy a change so that block bends by connecting the block of hard materials to the block of soft materials. Furthermore, because there are many children user, so the block of soft materials is preferred to hard materials. An object of the present invention, brought about in view of the circumstance described above, is to make available an assembled block capable of assembling the block of hard materials and soft materials.

### Means for Resolving the Problem

The present invention to solve the problem is an assembled block set that can be assembled from assembly blocks formed from elastic materials, from rigid materials, or from an elastic material and a rigid material. Through-holes are formed in the assembly blocks, and they fit together by using assembly stick blocks that pass through the through-holes in the blocks. Therefore, blocks connectable can be formed by using the block of soft materials or the block of hard materials.

The assembled block can be formed of a cap shape, and an article of the stick shape can be fit together. The assembled block can be a container, and the assembled block set capable of fitting the container together can be formed. Furthermore, an assembled block having a plurality of convex portion provided to four sides of the main body of the blocks is formed, and the assembled block set capable of assembling can be formed by fitting a convex portion of other assembled block into a concave portion formed between said convex portions. A C-shaped ring member being partly cutting of allowing an assembled block to fit together can be formed.

In above configuration, the assembled block is formed by a resilient sheet, and thereby a foldable assembled block set having the elasticity can be formed by injecting gas. Assembled block set having hollow inside may be formed.

The assembled block set having the block formed by a solid body of the elastic material can be used. A solid body of the elastic material may be formed of an eraser. A solid body of the elastic material can be formed of the sweets such as gummies.

A reinforcement for increasing strength is provided in the assembled block and thereby the assembled block set of allowing the cylindrical shaped member pierceable in above throughhole to fit together can be formed. A building can be constructed by fitting a building material and the assembled block set together. A furniture can be constructed by fitting a furniture material and the assembled block set together.

An assembled block operation device capable of user's assembling the assembled block in virtual spaces can be configured by providing an information of the assembled block set and a necessary information in assembling the assembled block. WEB system capable of user's assembling the assembled block in virtual spaces can be configured by providing plurality of above assembled block operation device and by sharing the information of the assembled block between a other industries or same industry.

### Effects of the Invention

The present invention relates to an assembled block set that can be assembled from assembly blocks formed from elastic materials, from rigid materials, or from an elastic material and a rigid material. Through-holes are formed in the assembly blocks, and they can fit together by using assembly stick blocks that pass through the through-holes in the blocks. Therefore, blocks connectable can be formed by using the block of soft materials or the block of hard materials.

### BRIEF DESCRIPTION OF DRAWINGS

FIG. 1 is a perspective view illustrating an outlined configuration of an assembled block set in accordance with an embodiment of the present invention.

FIG. 2 is a perspective view illustrating an outlined configuration of an assembled block set in accordance with an embodiment of the present invention.

FIG. 3 is a perspective view illustrating an outlined configuration of an assembled block set in accordance with an embodiment of the present invention.

FIG. 4 is a perspective view illustrating an outlined configuration of an assembled block set in accordance with an embodiment of the present invention.

FIG. 5 is a front view illustrating an outlined configuration of an assembled block in accordance with an embodiment of the present invention.

FIG. 6 is a front view illustrating an outlined configuration of an assembled block in accordance with an embodiment of the present invention.

FIG. 7 is a front view illustrating an outlined configuration of an assembled block in accordance with an embodiment of the present invention.

FIG. 8 is a front view illustrating an outlined configuration of an assembled block in accordance with an embodiment of the present invention.

FIG. 9 is a front view illustrating an outlined configuration of an assembled block in accordance with an embodiment of the present invention.

FIG. 10 is a front view illustrating an outlined configuration of an assembled block in accordance with an embodiment of the present invention.

FIG. 11 is a perspective view illustrating an outlined configuration of an assembled block in accordance with an embodiment of the present invention.

FIG. 12 is a perspective view illustrating an outlined configuration of an assembled block in accordance with an embodiment of the present invention.

FIG. 13 is a perspective view illustrating an outlined configuration of an assembled block in accordance with an embodiment of the present invention.

FIG. 14 is a perspective view illustrating an outlined configuration of an assembled block in accordance with an embodiment of the present invention.

FIG. 15 is a perspective view illustrating an outlined configuration of an assembled block in accordance with an embodiment of the present invention.

FIG. 16 is a perspective view illustrating an outlined configuration of an assembled block set in accordance with an embodiment of the present invention.

FIG. 17 is a perspective view illustrating an outlined configuration of an assembled block in accordance with an embodiment of the present invention.

FIG. 18 is a perspective view illustrating an outlined configuration of an assembled block in accordance with an embodiment of the present invention.

FIG. 19 is a perspective view illustrating an outlined configuration of an assembled block in accordance with an embodiment of the present invention.

FIG. 20 is a perspective view illustrating an outlined configuration of an assembled block in accordance with an embodiment of the present invention.

FIG. 21 is a perspective view illustrating an outlined configuration of an assembled block in accordance with an embodiment of the present invention.

FIG. 22 is a perspective view illustrating an outlined configuration of an assembled block in accordance with an embodiment of the present invention.

FIG. 23 is a front view illustrating an outlined configuration of an assembled block in accordance with an embodiment of the present invention.

FIG. 24 is a front view illustrating an outlined configuration of an assembled block set in accordance with an embodiment of the present invention.

FIG. 25 is a perspective view illustrating an outlined configuration of an assembled block set in accordance with an embodiment of the present invention.

FIG. 26 is a perspective view illustrating an outlined configuration of an assembled block set in accordance with an embodiment of the present invention.

FIG. 27 is a perspective view illustrating an outlined configuration of an assembled block set in accordance with an embodiment of the present invention.

FIG. 28 is a cross-sectional view illustrating an outlined configuration of an assembled block in accordance with an embodiment of the present invention.

FIG. 29 is a perspective view illustrating an outlined configuration of an assembled block in accordance with an embodiment of the present invention.

### DESCRIPTION OF THE PREFERRED EMBODIMENT

### Preferred Embodiment 1

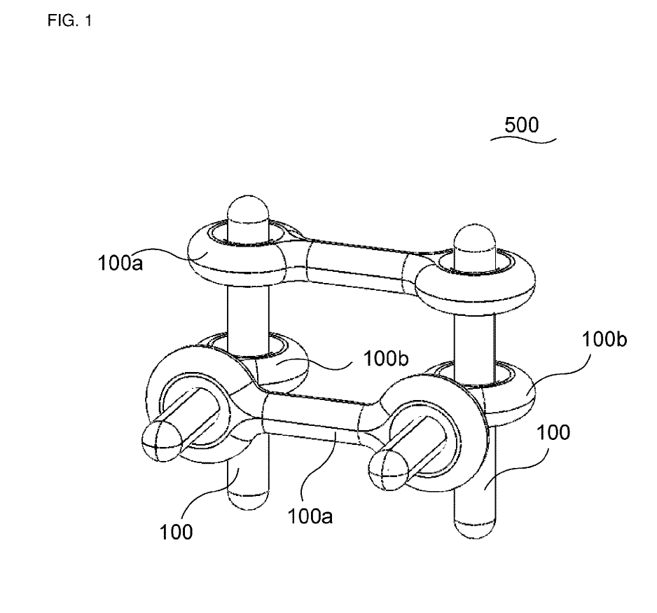

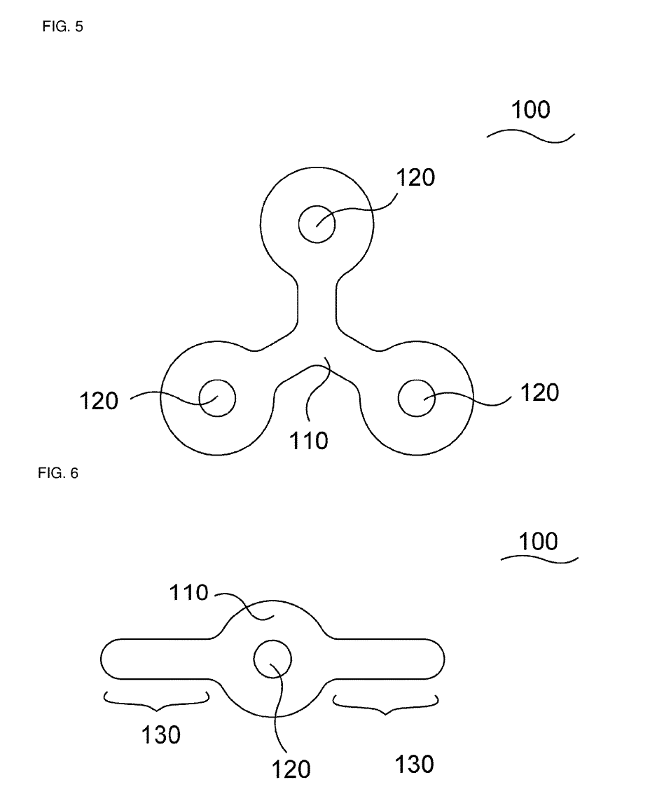

A block 100 and an assembled block set 500 in the following present invention are explained. FIGS. 1 to 4 are a perspective view illustrating an outlined configuration of an assembled block set in accordance with an embodiment of the present invention. FIGS. 5 to 27 are an outlined configuration of an assembled block or assembled block set in accordance with an embodiment of the present invention. However, the details of the all parts which do not directly-relate to the present invention will be omitted. A front view of a block 100 is described as follows, but, in the performing, a desired block 100 of thickness is formed. As shown, a block 100 of the present invention is block 100 formed with throughhole, and is assembled block set 500 fitting the stick type blocks 100 in the throughhole together. Assembled block set 500 is formed of an elastic member, and elastic materials may be put together and hard materials may be put together. Furthermore, elastic material and rigidity material can be put together.

Assembled block 100 of the present invention comprises an assembled block main body and a connecting portion (throughhole) for connecting the main body of block to one another. The connecting portion functions as connecting means. If blocks 100 can be connected, the any shape can be used. A spherical type block 100 or box type block 100, or stick type block 100 are considered. In the following blocks 100, a shape viewed from front is described, but, blocks 100 with desired thickness may be formed. The circular member of the following discussion may be rectangular.

FIG. 1 is an assembled block set 500 fitting the assembled block 100 of the present invention together. Two rings type-assembled block 100a wherein two circular members continuously connected to the both ends of a stick type assembled block 100, one ring type-assembled block 100b wherein circular member continuously connected to the both ends of a stick type assembled block 100, and a stick type assembled block 100 are fit together. Stick type assembled block 100 is fitted in both apertures of two ring type assembled block 100a, one ring type assembled block 100b is fitted in the stick type assembled block 100, and a stick portion of the each one ring type block 100b is fitted in aperture of other two ring type assembled block 100a.

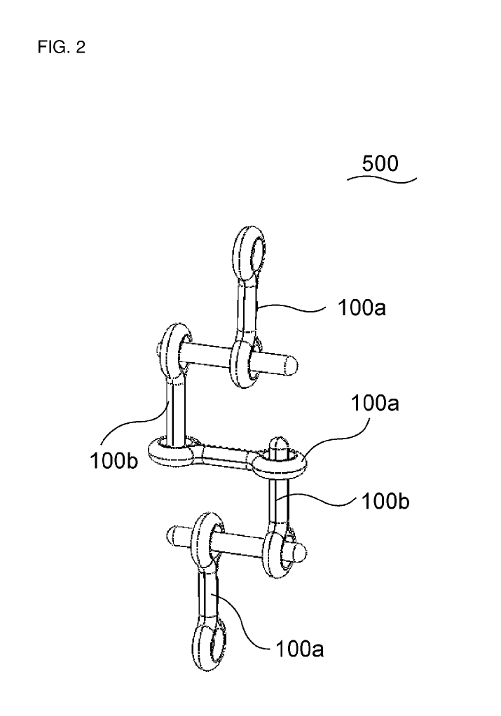

FIG. 2 is assembled block set 500 fitting the assembled block 100 of the present invention together. A two ring type assembled block 100a, stick type assembled block 100 and one ring type assembled block 100b are put together alternately. Stick type assembled block 100 is fitted in one of apertures of the two ring type assembled block 100a, One ring type assembled block 100b is fitted in one end of the stick type assembled block 100, And another end of the stick portion of the one ring type block 100b is fitted in aperture of the two ring type assembled block 100a.

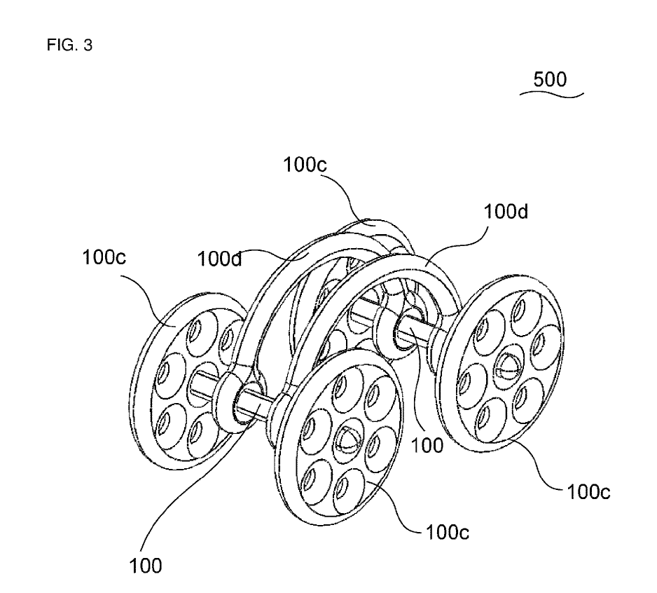

FIG. 3 is an assembled block set 500 fitting an assembled block 100 of the present invention together. Four circle-shaped assembled blocks are used as wheels, and as a whole an assembled block set 500 imitating shape of a car is formed. The circle-shaped assembled block has an aperture in the center of the circular plate shaped block. And a wheel type assembled block 100c is formed by symmetrically forming a plurality of aperture with respect to the center aperture. Then a bending stick type assembled block 100d is formed by continuously connecting a two circular member to the both ends of a member bent into a semicircle shape. The rings of one end of the two bending stick type assembled blocks 100 are penetrated with above stick type assembled block 100. In this state, an assembled block set 500 imitating a car shape is formed by fitting the wheel type assembled block 100c to the both ends of the stick type assembled block 100.

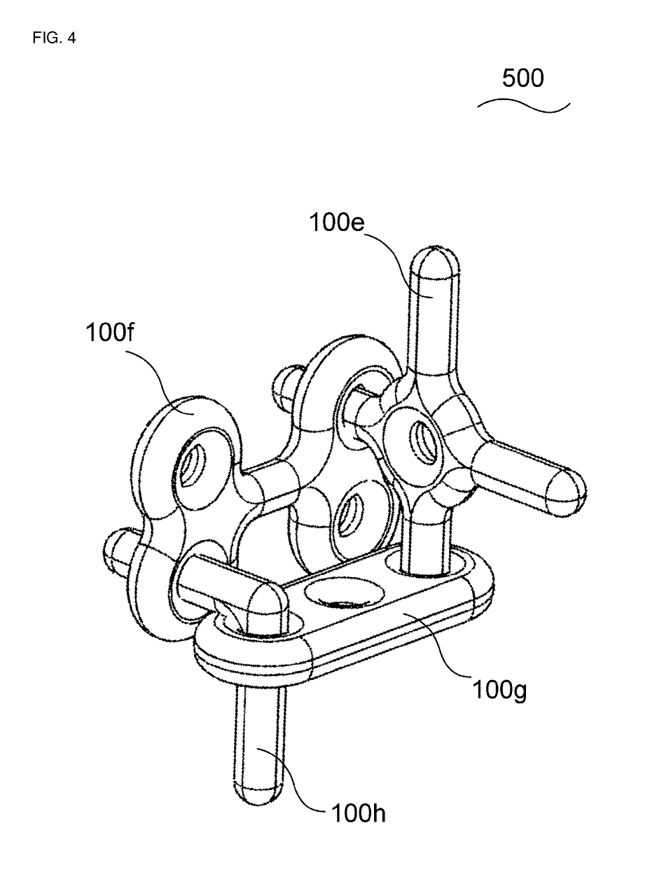

FIG. 4 is an assembled block set 500 putting an assembled block 100 of the present invention together. Total of four assembled blocks 100 are put together. A central ring type assembled block 100e is formed by continuously connecting a stick member, in 4 directions centering around a circle-shaped member. And a four ring type assembled block 100f is formed by continuously connecting the block wherein two circular member continuously connects to the both ends of the stick member. Furthermore, an oval ring type assembled block 100g having three apertures to an oval type block is formed, and an assembled block 100h bent to L shape is formed. Assembled block set 500 is formed by fitting the four kinds of above assembled block together. A central ring type assembled block 100e is inserted into one aperture of the four ring type assembled block 100f, and L-shaped assembled block 100h is inserted into other aperture. And, the stick portion of the central ring type assembled block 100e and other end of the L shaped type assembled block 100h, are inserted into the two apertures of the oval ring type assembled block 100g.

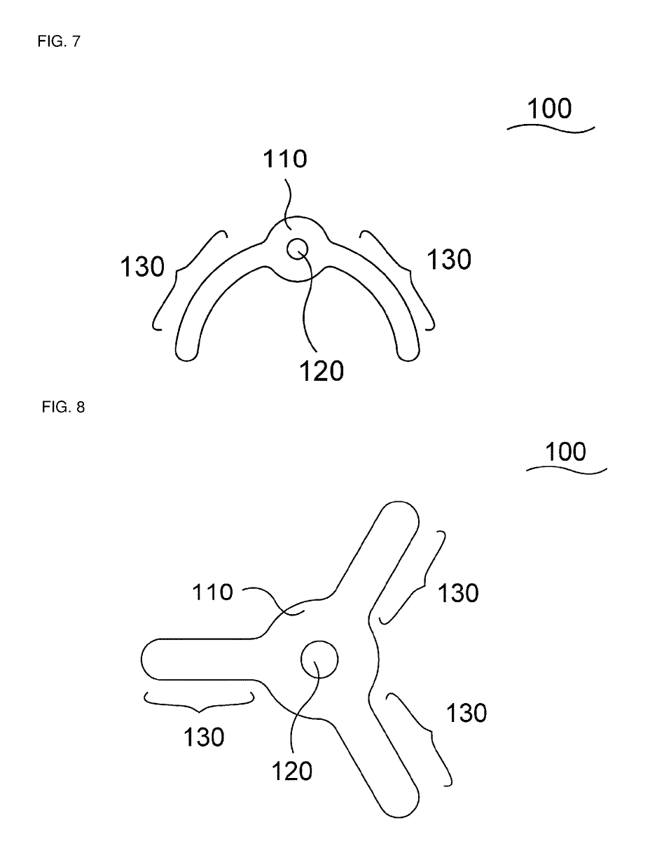

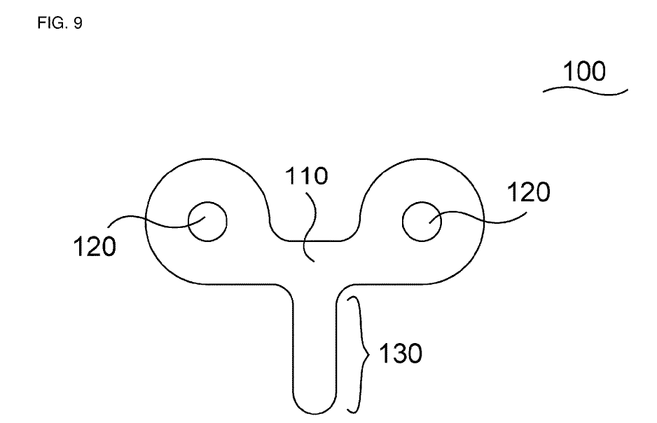

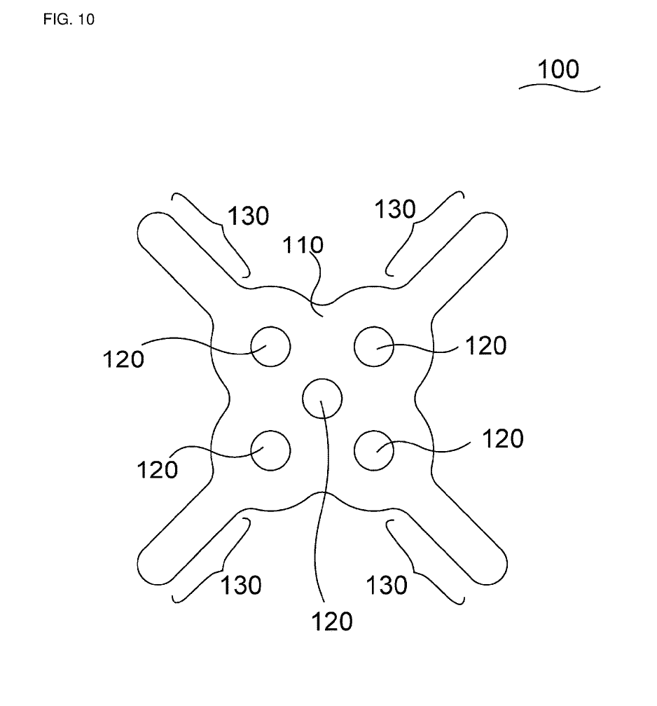

The block of the following shapes can be formed as other assembled block 100. In the following blocks 200, a shape viewed from front is described, but, blocks 200 with desired thickness may be formed. In the any blocks 100, throughhole 120 is formed to the main body of block 110. The circular member of the following discussion may be rectangular. FIG. 5 is block 100 of the shape to arrange three circular member in triangular vertex and continuously connect each circular member with a stick member. FIG. 6 is block 100 of the shape to place a circular member in the center and to connect 2 stick members 130 at the both ends of the circular member continuously. FIG. 7 is block 100 of the shape to bend 2 stick members 130 into an arc shape and to connect to an circular member placed in the center continuously. FIG. 8 is block 100 of the shape connecting three stick members 130 to a circular member placed in the center. The angle between stick members 130 is formed into around 120 degrees. FIG. 9 is block 100 of the shape connecting a stick member 130 to the portion which coupled 2 circular members. FIG. 10 is block 100 of the shape connecting 4 stick member 130 to the member which roundly protrude 4 corners of an oval member or rectangular member

As for the forming method of block 100, well-known technique can be used. That is, desirable shape of block 100 can be formed by means of injection molding of a high polymer resin. Of course block 100 of the present invention is formed of an elastic member or a rigid member. An elastic member may be formed by filling gas such as the air into the main body of block 110, or an assembled elasticity block may be formed of an elastic material such as the gummy. Elastic material of the assembled block may be formed of sweets.

### Preferred Embodiment 2

Block 100 having throughhole was explained with detailed description of the preferred embodiment 1. In the present embodiment, block having a cap shape, container, or C-type handle is described. Blocks are fit together by penetrating of a stick type block through a throughhole 120 of the block, thereby an assembled block set 500 is formed. In the following blocks, a shape viewed from front is described, but, blocks with desired thickness may be formed.

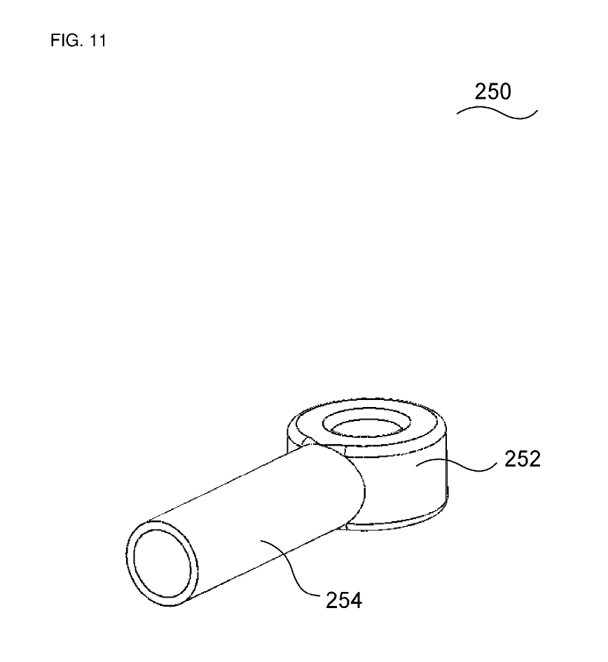

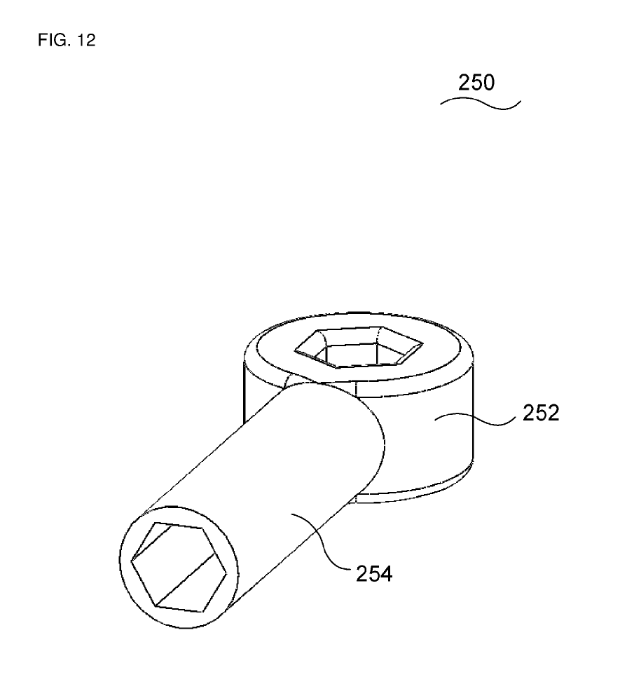

FIG. 11 shows an example of a cap shaped block 250. It has the shape connecting one stick type block 254 (hereinafter referred to as penetration block 252) into the block having throughhole. A stick type block 254 also has throughhole. The shape of the throughhole can be selected by a shape of the block 250 assembled. Circle shape or rectangular shape can be used, and the hexagonal throughhole can be used as illustrated in FIG. 12.

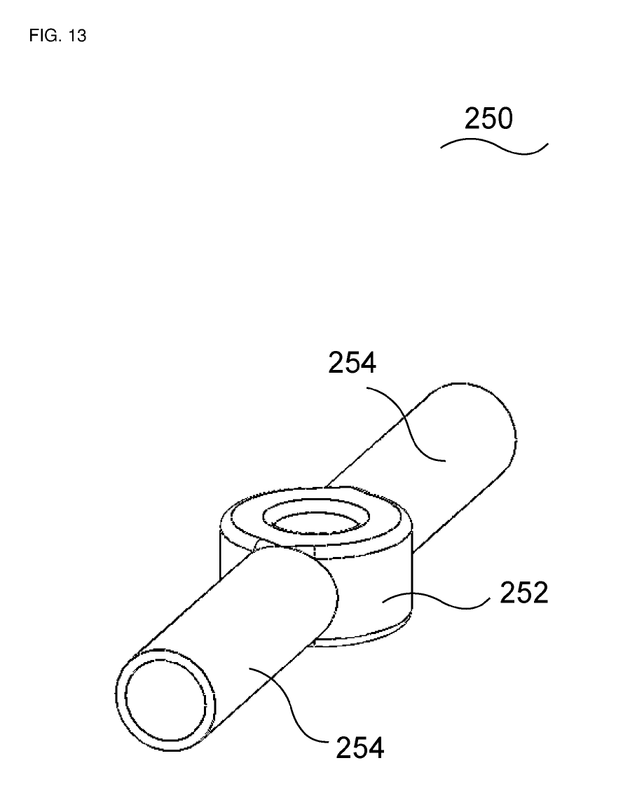

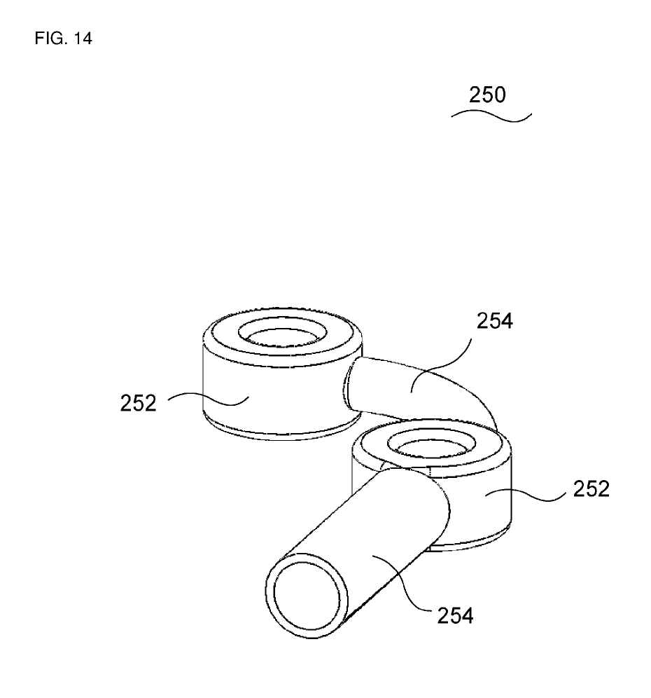

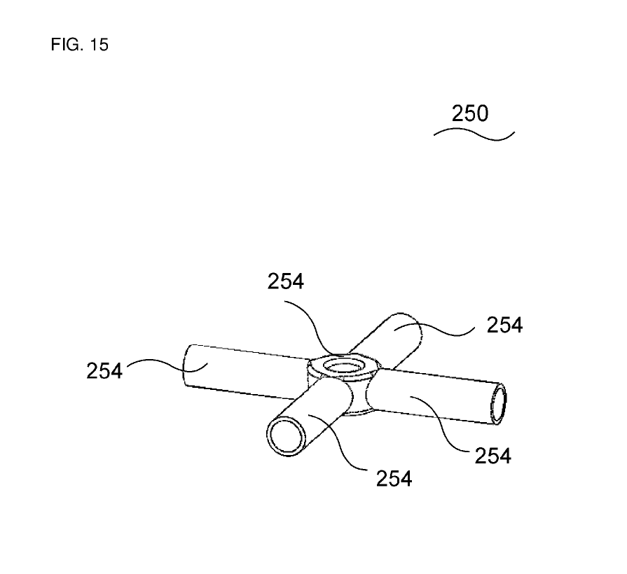

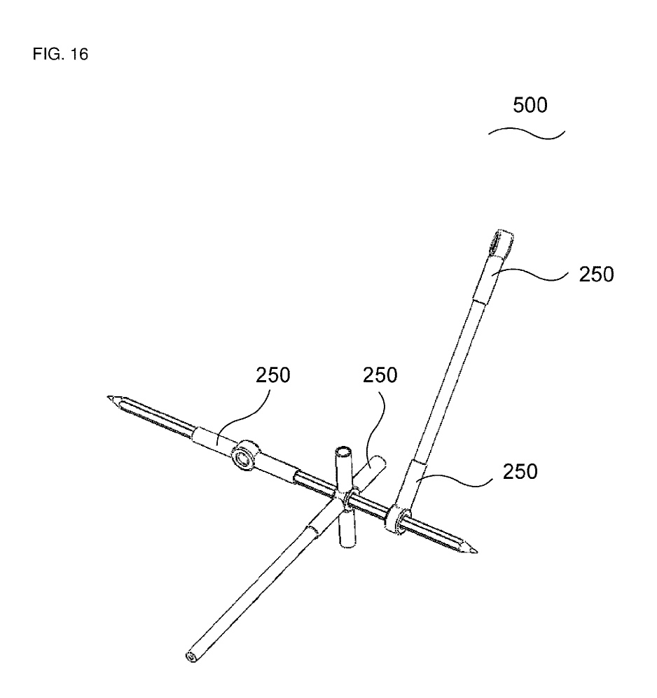

A cap type block 250 can be formed by connecting a plurality of stick type block 254, For example, as shown in FIG. 13, the cap type block 250 can be formed by connecting two stick type block 254 with a throughhole block 252. A plurality of throughhole block 252 can be used. As shown in FIG. 14, two throughhole blocks 252 are prepared, and cap type block 250 can be formed by alternately connecting two stick type block 254 and throughhole block 252. FIG. 14 shows a block 254 capable of bending the stick type block 254, but a straight stick can be used. Furthermore, plurality of stick type block 254 may be connected to one throughhole block 252. In the FIG. 15, cap type block 250 is formed by connecting 4 stick type blocks 254 with one throughhole block 252. Cap type block 250 may be formed of an elastic member. Cap type block 250 formed as described above is used in various embodiment. As shown in FIG. 16, an assembled block set 500 is formed by fitting pencils and cap type blocks 250 together.

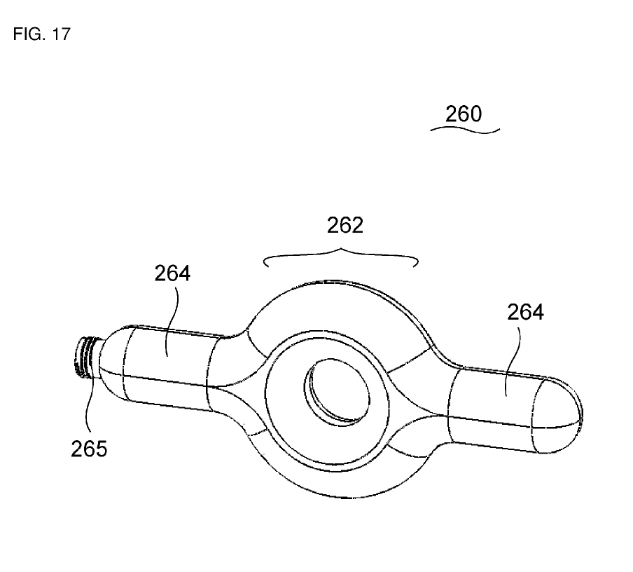

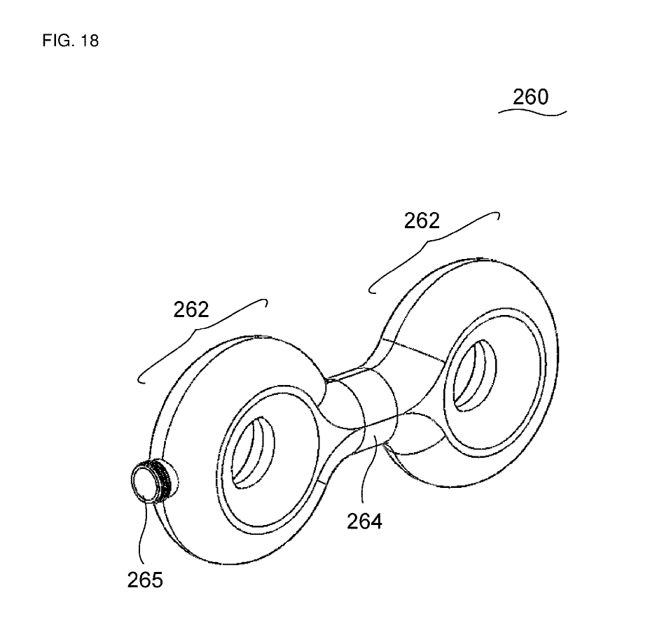

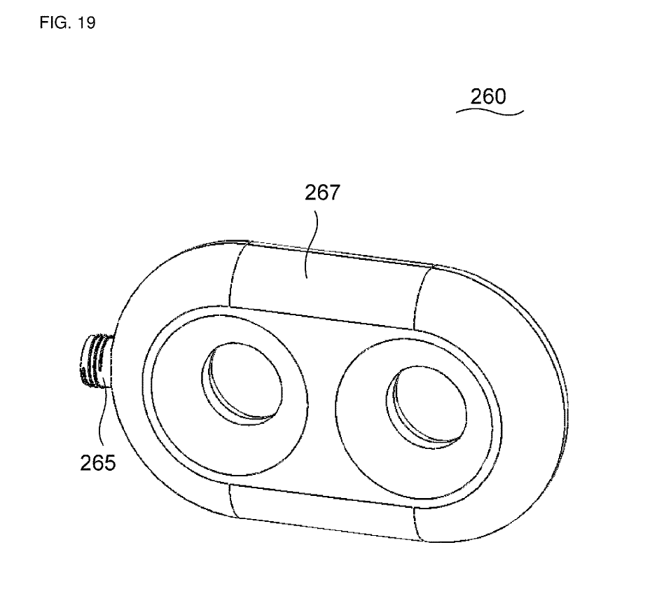

Next, a container type assembled block set will be explained. FIGS. 17 to 19 shows an example of a container type assembled block 260. FIG. 17 shows an assembled block connecting one throughhole block 262 with two stick type block 264. The stick type block 264 is connected to the throughhole block 262 smoothly. A container type assembled block 260 has an inlet portion 265 for taking out contents. FIG. 18 shows an assembled block connecting two throughhole block 262 with one stick type block 264. The stick type block 264 is connected to the throughhole block 262 smoothly. A container type assembled block has an inlet portion 265 for taking out contents. FIG. 19 shows an assembled block 260 wherein two throughholes are formed on an elliptic type block 267. A container type assembled block has an inlet portion for taking out contents.

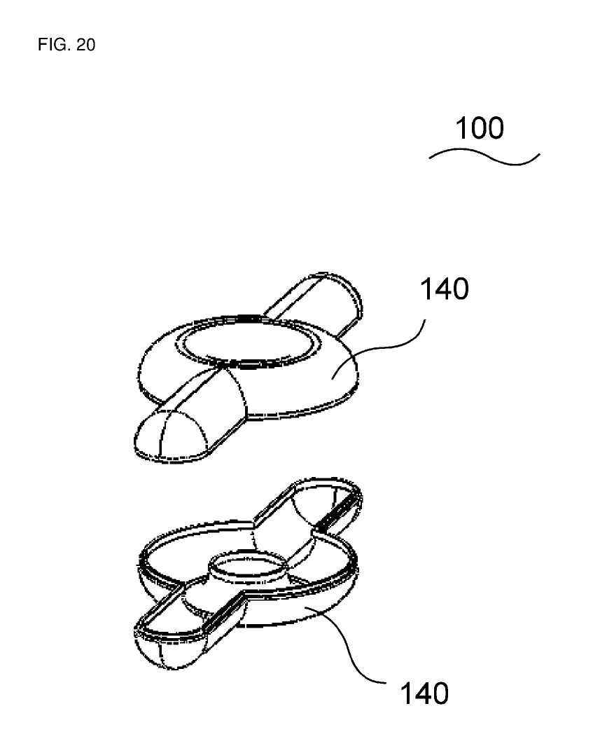

As shown in FIG. 20, assembled block 100 can be divided up and down. Each Block 140 divided up and down can be engaged and can connect to one another. Container type assembled block 260 can be formed by engaging and by connecting to one another.

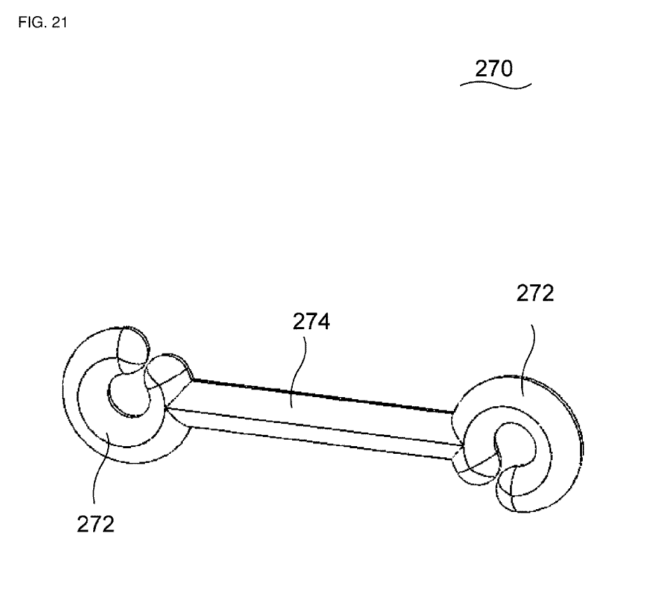

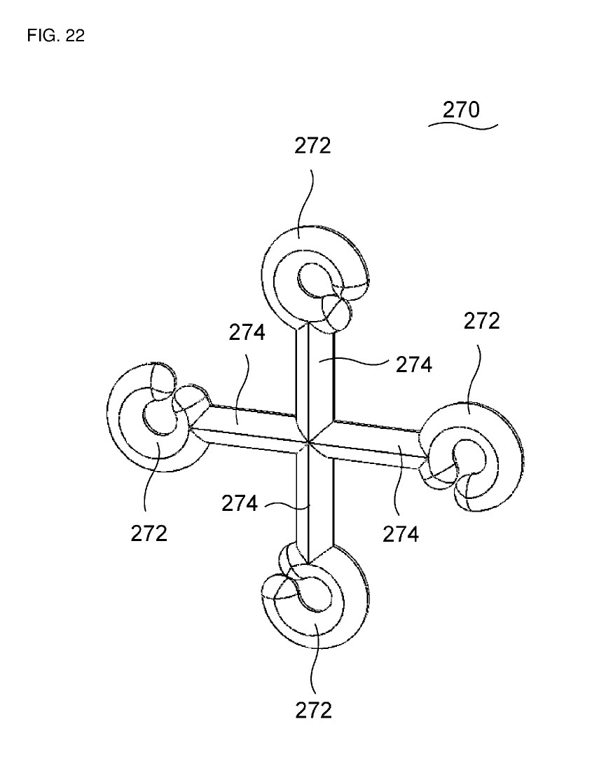

Then, Block 270 having a C ring type handle partly cut will be explained as block capable of fitting together an assembled block set 500. As shown in FIG. 21, a stick type block can be held to the notch by partly cutting the ring of the handle portion. The block 270 connects the stick type block 274 with C type ring 272. Therefore, combination can be done even if the sizes of the blocks are different to some extent. It prevents from falling out in parallel toward stick portion by cutting the ring portion vertically placed to the stick portion. As illustrated in FIG. 22, four C type rings 272 can be formed. The stick members are perpendicularly connected to each other, and an assembled block 270 having C ring type handle is formed by connecting a C type ring 272 with the edge of the stick member. A stick type block can be held to the notch by partly cutting the ring of the handle portion. A block 270 connects the stick type block 274 with C type ring 272. Therefore, combination can be done even if the sizes of the blocks are different to some extent. It prevents from falling out in parallel toward stick portion by cutting the ring portion vertically placed to the stick portion.

In the assembled block of the present example, a block having the elasticity can be formed by forming gas feeding port in the assembled block formed of a resilient sheet and by injecting gas such as the air. Furthermore, an elastic block having hollow section inside thereof can be formed by ejection molding or a molding flask. Furthermore, the assembled block of the present example can be formed of a solid body of the elastic material such as an eraser or the sweets.

It can combine to the cylindrical shaped member capable of penetrating through the throughhole by including a reinforcement (using the well-known member) for improving the strength to the assembled block. For example, assembled block set can be formed by fitting rigid material such as the iron pipe with the assembled block together. Therefore, a building and furniture can be constructed by a combination of assembled block set with construction materials formed as above. The product of the shape as shown in FIGS. 1 to 3 can be constructed by fitting assembled block according to detailed description of the preferred embodiment 1 to 3 together,

### Preferred Embodiment 3

With detailed description of the preferred embodiment 1 and 2, a block 100 to be assembled by a stick member's penetration to throughhole was explained. In the present embodiment, block 300 having connecting portion for connecting by fitting a concave portion and a convex portion together is described. In the following blocks 300, a shape viewed from front is described, but, blocks 300 with desired thickness may be formed. A circle shaped member can be used instead of the rectangular member in the following discussion.

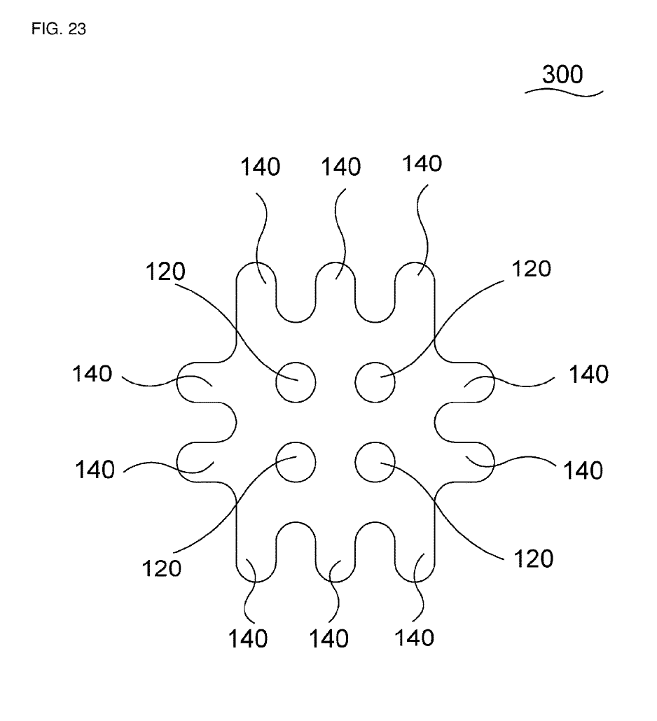

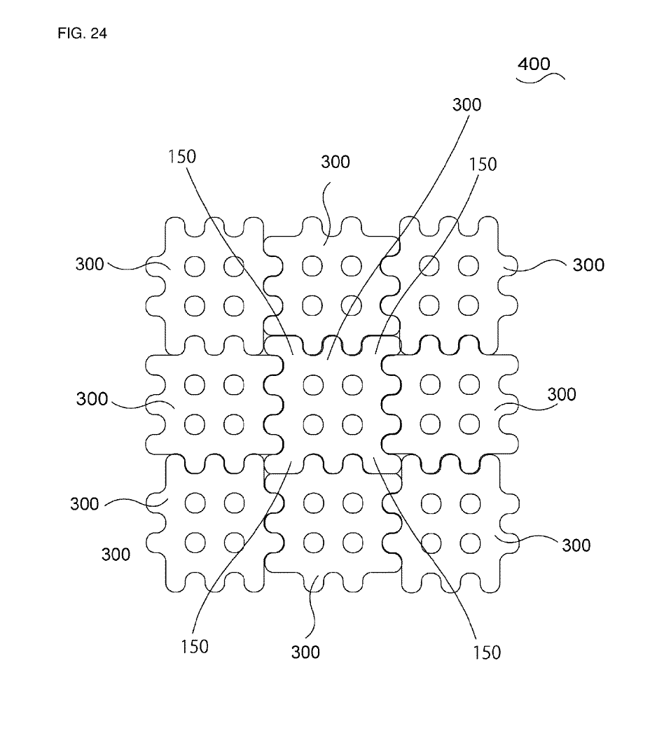

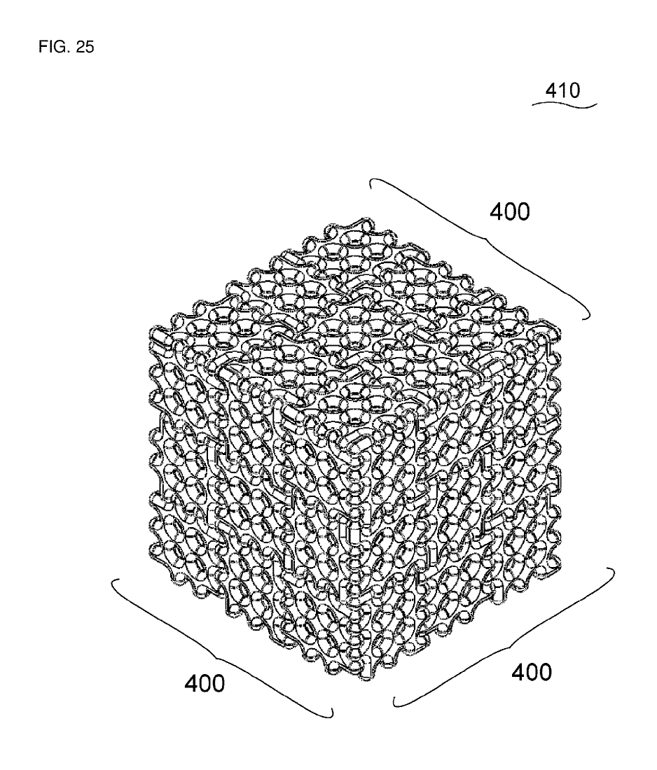

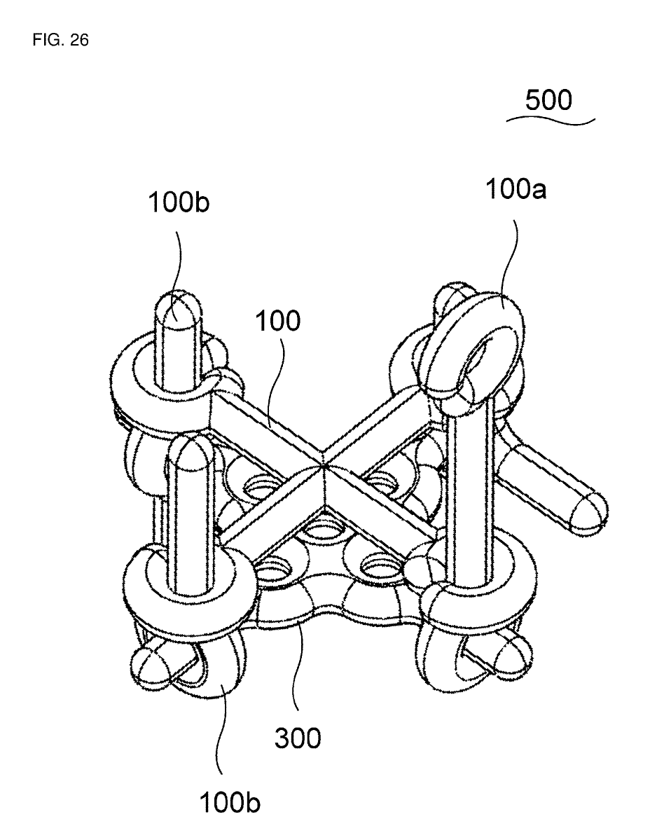

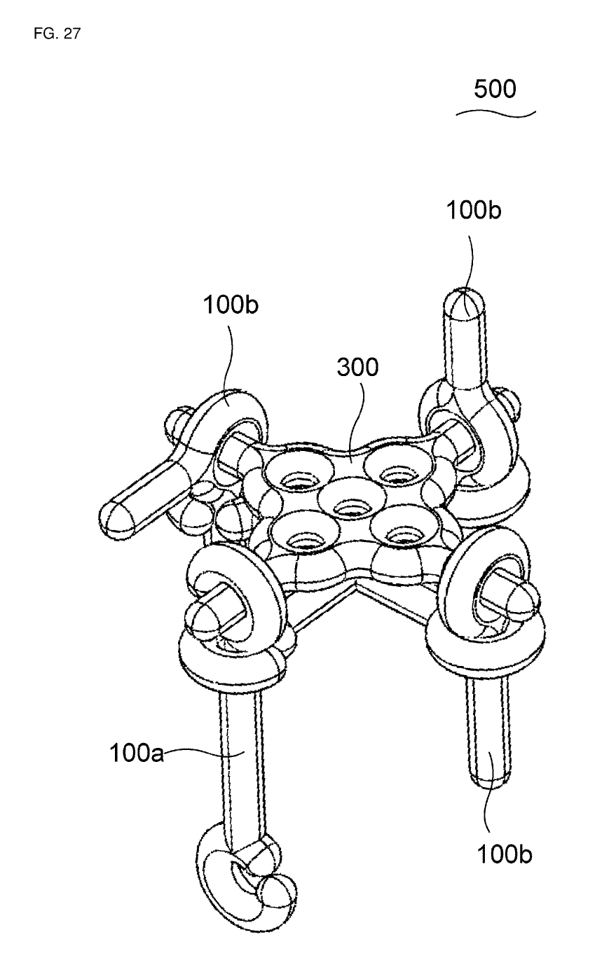

Regarding a pair of side part facing each other of the rectangular member, FIG. 23 shows a block 300 which formed three convex portion 140 in the one side part and formed two convex portion 140 in the other side part. Because a concave portion is formed between convex portion 140 and convex portion 140, a shape of concave portion and convex portion 140 is formed so as to be able to fit the concave portion and convex portion 140 together. A wall surface can be formed by connecting the blocks 300 to one another. FIG. 24 shows a block group 400 (wall surface) centrally placing the blocks 300 which formed bending convex portion 150 at the four angles, and fitting the block 300 together. It is placed so that the gap in block group 400 can be filled by the central bending convex portion 150. As shown in FIG. 25, solid body with three surfaces or cube 410 with 6 surfaces can be formed by connecting wall surfaces to one another. As shown in FIG. 26 and FIG. 27, a block 300 having connecting portion to fit a concave portion and a convex portion together and an assembled block 100 as an example of the one ring type assembled block 100b are fit together. The result is that assembled block set 500 can be formed.

In the assembled block of the present example, a block having the elasticity can be formed by forming a gas feeding portion in assembled block formed of a resilient sheet and by feeding the gas such as the air. Furthermore, an elastic block having hollow section inside thereof can be formed by ejection molding or a molding flask. Furthermore, the assembled block of the present example can be formed of a solid body of the elastic material such as an eraser or the sweets.

It can combine to the cylindrical shaped member capable of penetrating through the throughhole by providing a reinforcement (using the well-known member) for improving the strength to the assembled block. For example, assembled block set can be formed by fitting rigid material such as the iron pipe with the assembled block together. Therefore, a building 500 and furniture 600 as shown in FIG. 26 and FIG. 27 can be constructed by a combination of assembled block set with construction materials formed as above.

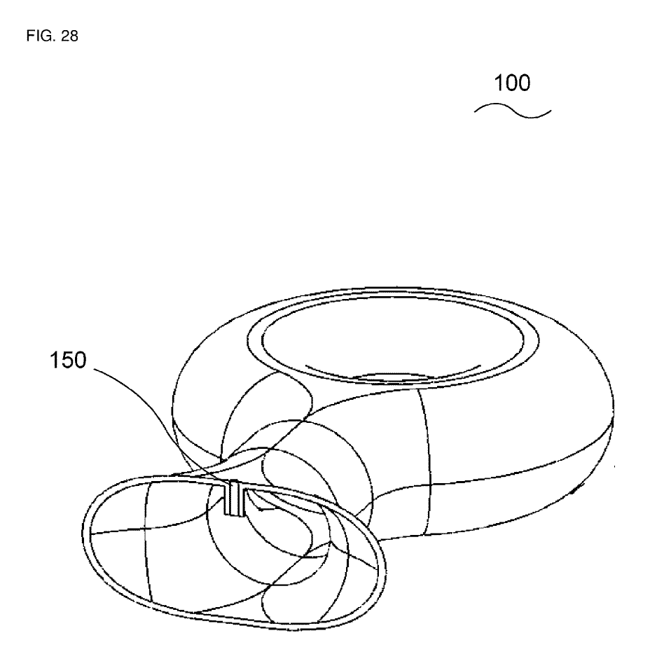

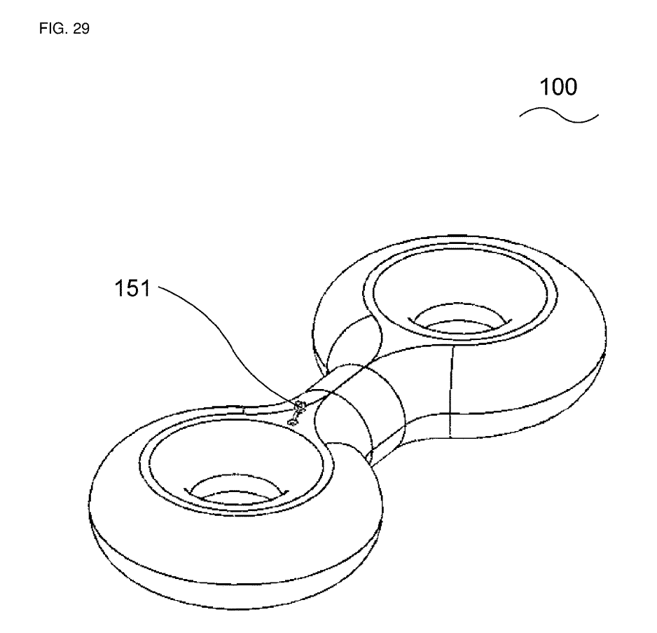

And when assembled block of the present invention is used as an elastic member, an air inlet as shown in FIG. 28 and FIG. 29 is formed. FIG. 28 is a cross-section perspective view of assembled block 100 of the present invention. A block 100 for filling air by inserting the needle for injecting air in aperture 150 for filling with air (a stopper to insert and remove a needle) is shown. FIG. 29 is block 100 of lid type 151.

### Preferred Embodiment 4

With detailed description of the preferred embodiment 1, 2, 3, connection method of the block 100 and 300 were described. In the present embodiment, a connection method of block 100,300 by using a virtual space on WEB will be explained. As follow, a block 100 will be explained as a representative. Beforehand, the information of the assembled block (either 3D or 2D are enough) and necessary information in assembling the assembled block 100 are registered. For example, a shape of the concave portion or the convex portion 140 of an assembled block 100 and the information of which blocks 100 connect with which blocks 100 are registered. And the virtual space display terminal of the user is connected to the virtual space control unit. The picture of the assembly block of the virtual space viewed from the viewpoint place which the user specifies is displayed on the display terminal. In this manner, based on information of the assembled block 100, the block 100 can be connected on a virtual space. Therefore, an assembled block operation device capable of user's assembling the assembled block 100 in virtual spaces can be configured.

WEB system capable of user's assembling the assembled block 100 in virtual spaces can be configured by providing plurality of above assembled block operation device and by sharing the information of the assembled block between a other industries or same industry, A well-known technique can be used about a software and a device necessary for the operation in the virtual space.

### Preferred Embodiment 5

With detailed description of the preferred embodiment 1, connection method of block 100 and 300 were described. In the present embodiment, a connection method of the block 100, 300 using a vending machine is described. As follow, a block 100 will be explained as a representative. Beforehand, the information of the assembled block (either 3D or 2D are fine) and necessary information in assembling the assembled block 100 are registered. For example, a shape of the concave portion or the convex portion 140 of an assembled block 100 and the information of which blocks 100 connect with which blocks 100 are registered. And display section of the vending machine displays a picture of assembled block 100 of the virtual space. In this manner, based on information of assembled block 100, the explanation about the connection of block 100 can be performed on the display section of the vending machine. A vending machine displaying the necessary block 100 for assembling the assembled block 100 or displaying a coupling unit can be constructed. A well-known technique is used about a software and a device necessary for operation of a vending machine and the display section of a vending machine.

### Preferred Embodiment 6

Other usage of the assembled block will be explained. For example, as shown in FIGS. 26, 27, a structure (an assembled block set 500) can be constructed by putting together the assembled block. As follow, a block 100 will be explained as a representative. Assembled block 100 can be formed by rigidity material. And, block 100 formed of the elastic material can be fit together to one another, or block 100 formed of the rigidity material can be fit together to one another. Or a block 100 formed of elastic material and block 100 formed of rigidity material can be fit together.

The assembled block 100 is formed of elastic sheet as elastic material. Assembled block 100 with bounce like a ball can be formed by injecting the gas such as air. In this case, it can be folded after the use. Assembled block 100 may be formed by a solid body of the elastic material such as sweets like a gummy candy or erasers.

As shown in FIG. 30, a building 550 can be constructed by fitting assembled block 100 with a building material together. For example, a building 550 can be constructed by fitting an assembled block 100 and an iron pipe together. The Building 550 can be constructed by a combination with the well-known building material. Furthermore, as shown in FIG. 31, a furniture 600 can be constructed by fitting an assembled block 100 with a well-known furniture material together, It can be used as building material and furniture material by adding reinforcing materials to an assembled block 100 for increasing in strength.

### INDUSTRIAL APPLICABILITY

The present invention relates to an assembled block set that can be assembled from assembly blocks formed from elastic materials, from rigid materials, or from an elastic material and a rigid material. Through-holes are formed in the assembly blocks, and it can be assembled using assembly stick blocks that pass through the through-holes in the blocks. Therefore, blocks connectable can be formed by using the block of soft materials or the block of hard materials, which makes them industrially useful.

### LEGEND

100,300: assembled block
110: Main body of blocks
120: throughhole
130: stick members
140: convex portion
150: bending convex portion
400: block group

1. An assembled block set, comprising:
an assembled blocks containing a through-hole;
an assembly stick blocks for fitting the throughhole of the assembled block, and capable of fitting the assembled blocks together;
wherein said assembled block set can be connected by the said blocks formed of an elastic material and/or by the said blocks formed of a rigidity material.

2. The assembled block set according to claim 1, wherein
said assembled block is cap, and can fit an article of the stick shape together.

3. The assembled block set according to claim 1, wherein
said assembled block is a container
and can fit said container together.

4. The assembled block set according to claim 1, further comprising:
a plurality of convex portion provided to four sides of the main body of the assembled blocks;
wherein said assembled block set can be fit together by fitting a convex portion of other assembled block into a concave portion formed between said convex portion.

5. An assembled block set, comprising:
a C shaped ring member being partly cutting capable of fitting an assembled block according to claim 1 together.

6. The assembled block set according to claim 1, wherein
said assembled block is formed by a resilient sheet,
gains an elasticity by injecting a gas,
and is foldable.

7. The assembled block set according to claim 1, wherein
an inside space of said assembled block have a hollow.

8. The assembled block set according to claim 1, wherein
said assembled block is formed by a solid body of the elastic material.

9. The assembled block set according to claim 8, wherein
said solid body of said elastic material is an eraser.

10. The assembled block set according to claim 8, wherein
said solid body of said elastic material is a sweets.

11. The assembled block set according to claim 1, further comprising:
a reinforcement for increasing strength provided in the assembled block;
a cylindrical shaped member pierceable in the throughhole; wherein said assembled block can fit said cylindrical shaped member together.

12. A building, comprising:
an assembled block set according to claim 11;
wherein said building is constructed by fitting a building material with said assembled block set according to claim 11 together.

13. A furniture, comprising:
an assembled block set according to claim 11;
wherein said building is constructed by fitting a furniture material with said assembled block set according to claim 11 together.

14. An assembled block operation device, wherein
said assembled block operation device is capable of user's assembling the assembled block in virtual spaces by providing an information of the assembled block set according to claim 1 and a necessary information in assembling the assembled block.

15. A WEB system, comprising:
a plurality of in assembled block operation device according to claim 14;
wherein said WEB system can fit the said assembled block together in a virtual space by sharing the information of the assembled block between a other industries or same industry.
